(19) United States
(12) Patent Application Publication
(10) Pub. No.: US 2003/0152151 A1
(43) Pub. Date: Aug. 14, 2003

(54) Rate control method for real-time video communication by using a dynamic rate table

(76) Inventors: Chao-Ho Hsieh, Kaohsiung City (TW); Jyi-Chang Tsai, Kaohsiung City (TW)

Correspondence Address: BACON & THOMAS, PLLC, 625 SLATERS LANE, FOURTH FLOOR, ALEXANDRIA, VA, 22314

(21) Appl. No.: 10/073,901

(22) Filed: Feb. 14, 2002

(51) Int. Cl. H04N 7/12

(52) U.S. Cl. 375/240.26; 375/240.16; 375/240.24; 375/240.12; 375/240.03

(57) ABSTRACT

The present invention relates to a bit rate control method for real-time video communication, which was developed in macroblock (i.e. MB) layer by utilizing a dynamic rate table. This table is designed offline with a training procedure by considering the MB complexity (i.e. SAD), quantization parameter (i.e. QP) and estimated coding bit counts. For each input MB, the rate control method utilizes its SAD value and the allocated number of bits to search the table to find the optimal QP value and encode the input MB by the optimal QP, and then utilizes the resulting coding bit count of the MB to update the rate table. Since the table will be automatically updated on a MB-by-MB basis every time after each macroblock being processed, it can rapidly track the local statistics of image blocks and control the bit rate accurately. In addition, the method only requires fixed-point computation, thus it significantly lowers down the cost in hardware implementation.

### FIELD OF THE INVENTION

The present invention relates to a rate control for video coding system, more particularly to a rate control method developed in macroblock layer for real-time video communication by utilizing a dynamic rate table to accurately control the bit rates generated from video encoder.

### BACKGROUND OF THE INVENTION

Rate control plays a critical role in video encoders such as H.26x and MPEG. It regulates the coded bit stream to meet the channel rate while keeps good picture quality. To perform the bit regulation, an encoder buffer is used to store the coded bits temporarily, which leads to the delay of data transmission. In real-time video communications, the end-to-end delay for transmitting video data needs to be very small. In such case, the buffer size must be small. When the number of bits generated for a particular frame is too large, the encoder usually skips the following frames to reduce the buffer delay and avoid buffer overflow. The frame skipping produces undesirable motion discontinuity in the reconstructed video sequence. Conversely, if a frame generates very small amount of bits, it will result in buffer underflow. Consequently, there may be periods of time in which no bit is transmitted through the channel, and hence some channel bandwidth is wasted. The goal of rate control is to avoid the buffer overflow (or equivalently frame skipping) and underflow by controlling the bit rates generated from the encoder.

Generally speaking, rate control for real-time video communication can be done at two layers, i.e. frame layer and macroblock (hereinafter referred to as MB) layer. Frame-layer rate control is necessary for all coding systems. However, it often cannot achieve fine regulation of bit rates. Some low-delay applications such as video phone and video conferencing require strict buffer regulations and less accumulated delay. A MB-layer rate control is necessary in these applications. Generally speaking, the rate control procedure in the MB-layer is more difficult as disclosed in the following prior arts:

Conventionally, the standard video coding systems, such as H.263 and MPEG, are based on motion compensation and DCT (discrete cosine transform). Motion estimation/compensation is typically performed on a 16×16 macroblock (MB) basis. After motion compensation, a motion-compensation difference frame (hereinafter referred to as residual frame) is obtained. Then, an 8×8 DCT is applied to the residual frame. The DCT coefficients are quantized with quantization parameter (QP) and then encoded with variable length code. In the standard video coding systems, each MB is permitted to utilize different quantization parameters to improve the coding performance.

MB-layer rate control procedure is as follows. Let rₖ(qₖ), dₖ(qₖ), and qₖ be the rate, distortion, and quantization parameters of the kth MB of a residual frame, respectively, and let M be the number of MBs in a frame, and B_{T} be the bit budget for the frame. The optimal MB-layer rate control is to find the quantization vector Q=(q₁, q₂, . . . qₖ) for all MBs that minimize the overall distortion D(Q):

$$D ( Q ) = {\sum }_{k = 1}^{M} {d}_{k} ( {q}_{k} )$$

, subject to rate constraint R(Q):

$$R ( Q ) = {\sum }_{k = 1}^{M} {r}_{k} ( {q}_{k} ) \leq {B}_{T}$$

The constrained optimization problem can be solved by Lagrange multiplier method. The solution is heavily dependent upon rate-distortion (hereinafter referred to as R-D) models. Many R-D models have been presented in the literatures. These models have several parameters. To track the statistics variation of video contents, the model parameters are updated on a frame basis or macroblock basis. However, the existing rate-control schemes based R-D models suffer from the following (at least parts of) drawbacks:

1. The R-D functions are obtained under the assumption of source statistics such as Laplacian distribution. Because the assumptions are only approximations, the R-D models are not always correct.

2. The R-D models are often related to the variance (σ²) of each residual MB. However, in the typical video coding systems, the criterion of sum of absolute difference (hereinafter referred to as SAD) is often employed for motion estimation to reduce computation; thus the R-D model derived based σ² on should be modified. The modification is often done in heuristics and is image dependent.

3. According to the R-D model, the quantization parameter QP is derived with the optimization method such as Lagrange multiplier. However, in the low-rate coding standards such as H.263, the change of quantization parameters between adjacent macroblocks in a group of block (hereinafter referred to as GOB) is restricted within two levels (i.e., −2 to +2). This reduces the contribution of optimization, and thus the target number of bits cannot be achieved accurately, and picture quality is degraded accordingly.

4. The R-D models involve floating-point computation, which results in high cost of hardware implementation and significant computational complexity.

### SUMMARY OF THE INVENTION

With respect to the drawbacks of the bit rate control implemented in the aforesaid R-D models, the inventor has devoted lots of efforts and times in researching and developing an effective and low-cost rate control algorithm in MB layer, and eventually invented a rate control method implemented in macroblock layer by utilizing a dynamic rate table for real-time video communication.

One object of the present invention is to develop an effective and low-cost rate control algorithm in MB layer, in which a dynamic rate table is designed according to the MB complexity (i.e., SAD), quantization parameter QP and coding bit counts. The table contains the estimate of the coding bit counts of a MB (with encoding complexity SAD) that is quantized with a particular QP value. For each input MB, the algorithm of the present invention utilizes the SAD value of the MB and the allocated number of bits to search the table and, to find out the optimal quantization parameter QP which minimizes the error between the coding bit count and the allocated bit count.

Another object of the present invention is that the table contains rate-distortion function implicitly, and is updated on a macroblock—by macroblock basis. Thus it can rapidly track the local statistics of image blocks and control the bit rate accurately.

Still another object of the present invention is that the algorithm performs only integer operations, therefore it can be easily implemented by a low-cost hardware circuit and can effectively low down the cost of video coding systems.

The above and other objects, features and advantages of the present invention will become apparent from the following detailed description taken with the accompanying drawings.

### BRIEF DESCRIPTION OF THE TABLES AND DRAWINGS

TABLE 1 is a comparison table of bit rates achieved by TMN8 and the rate control algorithm of the present invention in the H.263 CODEC.

TABLE 2 is a comparison table of the number of frame skipped and average PSNR for TMN8 and the control algorithm of the present invention in the H.263 CODEC.

FIG. 1(a) shows PSNR value at each frame of a video sequence entitled “Salesman” being encoded respectively by TMN8 and the control algorithm of the present invention under a bit rate of 64 kbps;

FIG. 1(b) shows PSNR value at each frame of a video sequence entitled “Silent” being encoded respectively by TMN8 and the control algorithm of the present invention under a bit rate of 48 kbps;

FIG. 2(a) shows the number of bits in the buffer at each frame of a video sequence entitled “Silent” being encoded respectively by TMN8 and the control algorithm of the present invention under a bit rate of 48 kbps;

FIG. 2(b) shows the number of bits in the buffer at each frame of a video sequence entitled “Mother & Daughter” being encoded respectively by TMN8 and the control algorithm of the present invention under a bit rate of 24 kbps;

FIG. 3(a) shows the actual coding bit counts at each frame of a video sequence entitled “Foreman” being encoded respectively by TMN8 and the control algorithm of the present invention under a bit rate of 112 kbps; and

FIG. 3(b) shows the actual coding bit counts at each frame of a video sequence entitled “Silent” being encoded respectively by TMN8 and the control algorithm of the present invention under a bit rate of 64 kbps.

### DETAILED DESCRIPTION OF THE PREFERRED EMBODIMENTS

In general, the determination of QP value of a residual MB should consider the MB complexity, e.g., variance (σ²) or SAD of the MB, and the available bit budget; namely,

QP=f(complexity, bit budget)

In the present invention, SAD rather than variance is adopted because it is available after motion estimation. As mentioned above, in the current existing rate-control schemes, the function ƒ(●) is derived based on R-D models. Instead of employing mathematical R-D model, the present invention designs a rate-complexity-QP table under the off-line condition, which is a 2-dimensional matrix b[SAD_{MBk}][QP]. The first parameter of the matrix, SAD_{MBk}, denotes the SAD value of the kth MB. The SAD is an integer in the range of (SADₘᵢₙ, SADₘₐₓ). The second parameter QP represents quantization parameter with QP=1,2, . . . ,31. The entry of the matrix represents the estimate of the coding bit counts of a MB (with encoding complexity SAD_{MBk}) that is quantized with a particular QP value. The table is designed off-line by a training procedure consisting of the following steps:

1) Feeding training video data into a video encoder (e.g., H.263) on a MB-by-MB basis;

2) Calculating the SAD value of the input MB, and encode it by using QP values from 1 to 31 respectively;

3) Recording the actual coding bit counts of the input MB after being quantized by each QP value;

4) Repeating the above steps for all MBs, and take the average of the actual coding bit counts for each (SAD, QP) pair, and then store the averages values into the matrix b[SAD_{MBk}][QP] until all entries of the matrix have been finished, the rate table is established.

The present invention utilizes SAD and QP to establish the rate table should be deemed as a specific embodiment thereof. Those who skilled in the art establish any other rate table according to the principle mentioned above merely, for example, by replacing SAD with variance σ² or replacing QP with other quantization parameters should be deemed as still within the scope and spirit of the present invention set forth here.

After establishing a rate-complexity-QP table under the off-line condition, the present invention then performs the frame-layer rate control and MB-layer rate control procedures on-line.

In the present invention, the object of the frame-layer rate control is to estimate the target bit counts for the current frame of which the rate control procedure is similar to that of TMN8. Before encoding the current frame, it is necessary to calculate the number of bits in the encoder buffer, which is also called as “buffer fullness”, by using the following equation:

W=max(Wₚᵣₑᵥ+D−R/F,0) (1)

, wherein D is the actual number of bits used for encoding the previous frame, Wₚᵣₑᵥ is the previous number of bits in the buffer, R is the channel rate, and F is the frame rate.

During encoding process, if the buffer fullness W is larger than a predefined threshold M, the encoder skips encoding frames until the buffer fullness is below M. For each skipped frame, the buffer fullness is reduced by R/F bits. In the present invention, if the threshold M of the current frame is set to be M=R/F, the maximum buffer delay will be M/R=1/F second.

In the present invention, the target bit counts for the current frame is estimated by using the following equation:

$${B}_{T} = \frac{R}{F} - Δ \qquad ( 2 )$$

, wherein Δ is defined below

$$Δ = \{ \begin{matrix}\frac{2 * W}{F} , W > Z * M \\ W - Z * M , otherwise\end{matrix}$$

, by default, z=0.1.

In general, the higher the complexity (SAD) of a MB, the larger number of bits is required. In the MB layer bit rate control of the present invention, in order to raise coding efficiency, it is necessary to perform initialization first to all MBs of the current frame. The initialization includes calculating and recording SAD value and motion vector for each MB after motion estimation/compensation, categorizing the MBs into compensable (SAD≦threshold) or uncompensable (SAD>threshold) type, categorizing further the uncompensable MBs into uncompensable inter-coding and intra-coding MBs, calculating the numbers of the uncompensable inter-coding and intra-coding MBs, and recording the numbers into the parameters Nᵢₙₜᵣₐ and Nᵢₙₜₑᵣ respectively;

Since the compensable MB doesn't need to be quantized, only the non-texture bits, such as indicator bits and/or motion vector bits, are inserted into headers of bit stream. On the other hand, the uncompensable MB needs to be quantized, therefore it contains the texture and non-texture information.

In the present invention, according to the H.263 specification, the partial non-texture information bits for a frame can be calculated before encoding by using the following equation:

$${B}_{uncade} = {\sum }_{m = 1}^{M} ( {B}_{COD} , {B}_{COD} + {B}_{MCBPC} + {B}_{CBPY} + {B}_{MVD} , {B}_{MVD} , 0 ) \qquad ( 3 )$$

, wherein M is the total number of MBs in a frame; (X, Y, Z, 0) means to select one from X, Y, Z and 0 depending on the coding modes, where X and Y correspond to the compensable type, Z corresponds to the uncompensable inter-coding, and 0 corresponds to the uncompensable intra-coding; B_{COD} is the number of bits for COD (coded macroblock indication) signal; B_{MCBPC} is the number of bits for MCBPC (macroblock type & coded block pattern for chrominance) signal; B_{CBPY} is the number of bits for CBPY (coded block pattern for luminance) signal; B_{MVD} is the number of bits for MVD (motion vector data).

As regards, the total number B_{code} of bits allocated to all uncompensable MBs can be calculated through the following equation:

B_{code}=B_{T}−B_{uncode}−B_{PH}−B_{GOBH} (4)

, wherein B_{T} is the bit budget for a frame and can be obtained from Eq. (2); B_{PH} is the bit counts for picture header; B_{GOBH} is the bit counts for GOB headers. In Eq. (4), B_{code} includes texture information bits and header bits of uncompensable MBs. However, the number of header bits for uncompensable MBs is unknown before quantization and coding. Thus the number of bits Bₐᵥₐ available for encoding only texture information of uncompensable MBs is estimated by using the following equation:

Bₐᵥₐ=B_{code}−B_{h-int ra}*N_{int ra}−B_{h-int er}*N_{int er} (5)

, wherein Bₐᵥₐ is the total number of bits allocated to the uncompensable MBs; Bₕ₋ᵢₙₜᵣₐ is the average header bit counts for intra MBs that have been encoded; Bₕ₋ᵢₙₜₑᵣ is the average header bit counts for inter MBs that have been encoded (without including motion-vector bit counts); Nᵢₙₜᵣₐ is the number of remaining intra MBs; Nᵢₙₜₑᵣ is the number of remaining inter MBs.

In Eq. (5), Bₕ₋ᵢₙₜᵣₐ and Bₕ₋ᵢₙₜₑᵣ can be calculated in a recursive manner by using the following equations:

$$\begin{matrix}{B}_{h - int ra}^{j} = \frac{1}{j} ( {B}_{h - int ra}^{j - 1} \times ( j - 1 ) + {b}_{h - int ra}^{j} ) & ( 6 ) \\ {B}_{h - int er}^{j} = \frac{1}{j} ( {B}_{h - int er}^{j - 1} \times ( j - 1 ) + {b}_{h - int er}^{j} ) & ( 7 )\end{matrix}$$

, wherein B_{h-int ra}^{j} is the average header bit counts over j intra MBs (the first MB to the jth MB);

$${b}_{h - int ra}^{j}$$

is the header bit counts for the jth intra MBs;

$${B}_{h - int er}^{j}$$

is the average header bit counts over j inter MBs (the first MB to the jth MB);

$${b}_{h - int er}^{j}$$

is the header bit counts for the jth inter MBs.

After Bₐᵥₐ being determined, the number of bits bₖ allocated to the kth MB will be estimated through the following equation:

$${b}_{k} = \frac{{B}_{ava} \times {SAD}_{{MB}_{k}}}{{\sum }_{k = 1}^{N} {SAD}_{{MB}_{k}}} \qquad ( 8 )$$

, wherein SAD_{MBk} is the SAD value of the kth MB; N is the total number of uncompensable MBs in a frame. In the present invention, the estimate of bₖ is based on the ratio of the SAD value of the kth MB to the sum of SAD values of all MBs, which means that the MB with larger value of SAD will be allocated the more coding bits. According to the same concept, numerous modifications and variations made by those skilled in the art should be deemed as not departing from the scope of the present invention set forth in the claims.

When the available number of bits Bₐᵥₐ and the number of bits bₖ allocated to the kth MB have been determined, the optimal QP value for the kth MB having SAD_{MBk} can be obtained, in accordance with the following equation, through searching from the table by using bₖ and SAD value:

$${QP}^{*} = {{min}^{- 1}}_{QP = 1 , 2 … , 31} \{ \vert {b}_{k} - b [ {SAD}_{{MB}_{k}} ] [ QP ] \vert \} \qquad ( 9 )$$

, wherein the inverse minimum means that the left hand side is equal to the value of QP that minimizes the difference of the estimated bit counts bₖ and target bit counts b[SAD_{MBk}][QP].

According to H.263 specification, the difference of QP value between two horizontal neighboring macroblocks is restricted to values in (−2, −1, +1, +2). Therefore, the optimal QP value obtained from Eq.(9) needs to be further adjusted to the value having a difference below 2 comparing with the QP value of a previous MB. The difference of QP value between the (k−1)th and kth neighboring macroblocks is denoted as, DQUANTₖ=QPₖ−QPₖ₋₁.

However, if the above mentioned process occurs at the beginning of a GOB or a frame (i.e. the first GOB), instead of calculating the macroblock quantization information DQUANT, the present invention utilize the QP value obtained to determine the picture quantization information PQUANT or group quantization information GQUANT, of which the determination procedure, different from that of DQUANT, is described as follows:

(a) If no uncompensable MB exists in the GOB, set GQUANT be any integer in the range of 1 to 31;

(b) If there is only one uncompensable MB in the GOB, set GQUANT=QP;

(c) If there are at least two uncompensable MBs in the GOB, the GQUANT is determined by using the following equation in accordance with the QP values of the first two uncompensable MBs:

$$GQUANT = \{ \begin{matrix}{QP}_{1} + 2 & if {QP}_{2} - {QP}_{1} \geq L , \\ {QP}_{1} & if - L < {QP}_{2} - {QP}_{1} < L \\ {QP}_{1} - 2 & if {QP}_{2} - {QP}_{1} \leq - L\end{matrix} \qquad ( 10 )$$

, wherein L is a positive integer, by default, L=5. The modification in Eq. (10) makes the QP difference of the first two uncompensable MBs of a GOB to be small. This further reduces the coding distortion. It is noted that if the first GOB is being processed, then calculate GQUANT by using Eq. (10) and let PQUANT=GQUANT.

In the present invention, the actual coding bit counts bₖ′ of the current MB is used to update the coding bit counts in the rate table. Various schemes can be used to achieve the update based on

$${b}_{k}^{′} .$$

The present invention developed an effective scheme in the following, which can reduce the cost of hardware implementation significantly. This scheme updates a one-dimensional shift array sb[SAD_{MBk}] rather than the two-dimensional rate table b[SAD_{MBk}][QP]. The shift array is of the size 1×SAD_{MBk}, which means that every SAD therein corresponds to an entity of the shift array. In the present invention, the sb[SAD_{MBk}] is updated by using the following equation:

sb[SAD_{MBk}]=(bₖ′+sb[SAD_{MBk}]−b[SAD_{MBk}][QP])/2 (11)

Then, the rate table is updated by simply adding sb[SAD_{MBk}] into the rate table, namely:

Updated coding bit count=b[SAD_{MBk}][QP]+sb[SAD_{MBk}] (12)

It should be noticed that every entity in the shift array sb[SAD_{MBk}] is initially set as zero, thus, after the rate table being established, it only needs to update sb[SAD_{MBk}], but not the table. The memory space required for the shift array is only 1/31 of that required for the table.

The principle of updating the rate table in the present invention is to use the actual coding bit counts bₖ′ of the current MB to update the estimated coding bit counts in the table. The above implementation by fixing the rate table and updating the one-dimensional shift array sb[SAD_{MBk}] is only one preferred embodiment of the present invention. Any modification and variation, based on the proposed update principle, made by those who skilled in the art, should be deemed as still within the scope and spirit of the present invention set forth here.

The existing R-D based rate control techniques involve several complex operations with floating-point accuracy, such as square root, multiplications and divisions. However, in the rate control method claimed in the present invention, the major operations are table look-up, counting, and simple multiplications/divisions with fixed-point accuracy which can be implemented with shift operations. Therefore, the rate control method of the present invention is much cheaper than the existing R-D model based rate control schemes from the viewpoint of hardware implementation. Compared to the R-D rate control schemes, the extra cost for the implementation of the present invention is the memory for the rate table. The memory size depends on the range of SAD(SADₘᵢₙ, SADₘₐₓ) and that of QP. In one embodiment of the present invention, if the range of QP and SAD are respectively 31 and 1660, the number of memory locations will be 31×1660 and the maximal bit counts of the table will be much less than 65535. It means that two bytes for each location are enough. Therefore, the memory size needed is only about 100 k bytes, of which the extra memory cost is very low under the current semiconductor technology.

With respect to the embodiments of the present invention, a basic version of H.263 codec is used to evaluate the embodiments of rate control algorithm, and the performances thereof are compared with TMN8 rate control. In this codec, the motion estimation is performed with full search algorithm (FSA) with 2:1 subsampling in both x and y directions for the concern of low computation. That is, the 16×16 MB is first reduced into 8×8 and then FSA is performed with search range of −15 to +15. The high level tools in H.263, such as advanced prediction and unrestricted motion vector, were not implemented. Six QCIF test sequences, each with frame rate of 10 Hz and various target bit rates, are conducted.

As to the embodiments, Table I shows the comparison of bit rates achieved by TMN8 and the rate control algorithm of the present invention, which indicates that the bit rate achieved by the rate control algorithm of the present invention is more closer to the target than TMN8. TABLE 2 compares the number of frames skipped and average PSNR (peak-to-noise ratio) for TMN8 and the rate control algorithm of the present invention, which indicates that the rate control algorithm of the present invention achieves higher PSNR value (average gain is about 0.8 dB); namely, better picture quality.

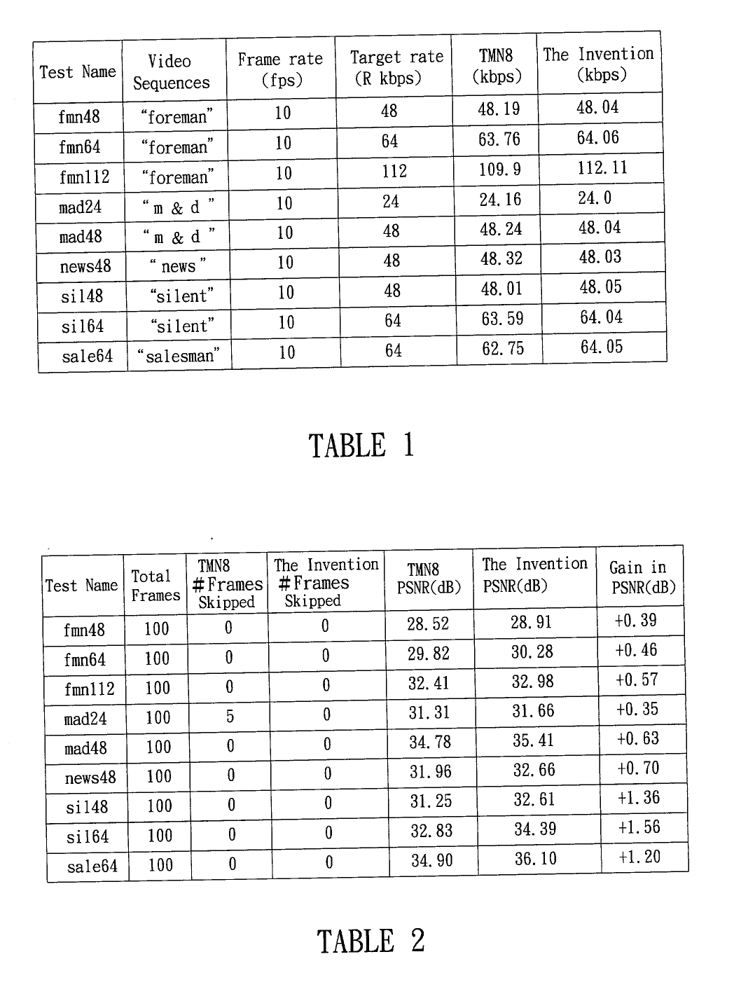

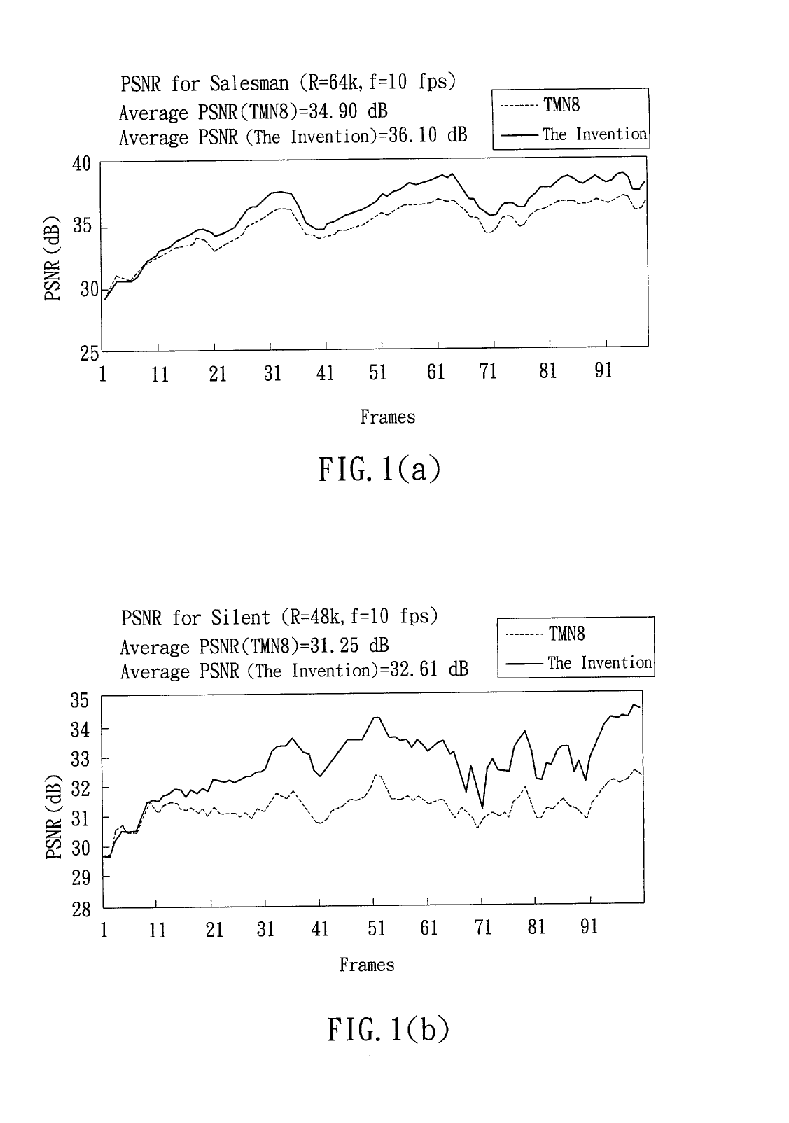

FIGS. 1(a) and 1(b) show PSNR value at each frame of different video sequences being encoded respectively by TMN8 and the rate control algorithm of the present invention under different bit rates. It apparently indicate that, on the first few frames, the rate control algorithm of the present invention achieves lower PSNR. However, it rapidly passes over TMN8 and keeps beyond until the end of the sequence. This indicates that initially the dynamic rate table is not so good, but it quickly catches the video statistics and tracks the variation of video contents well. Therefore, the dynamic rate table enables the present invention to be more accurate to reflect the video contents.

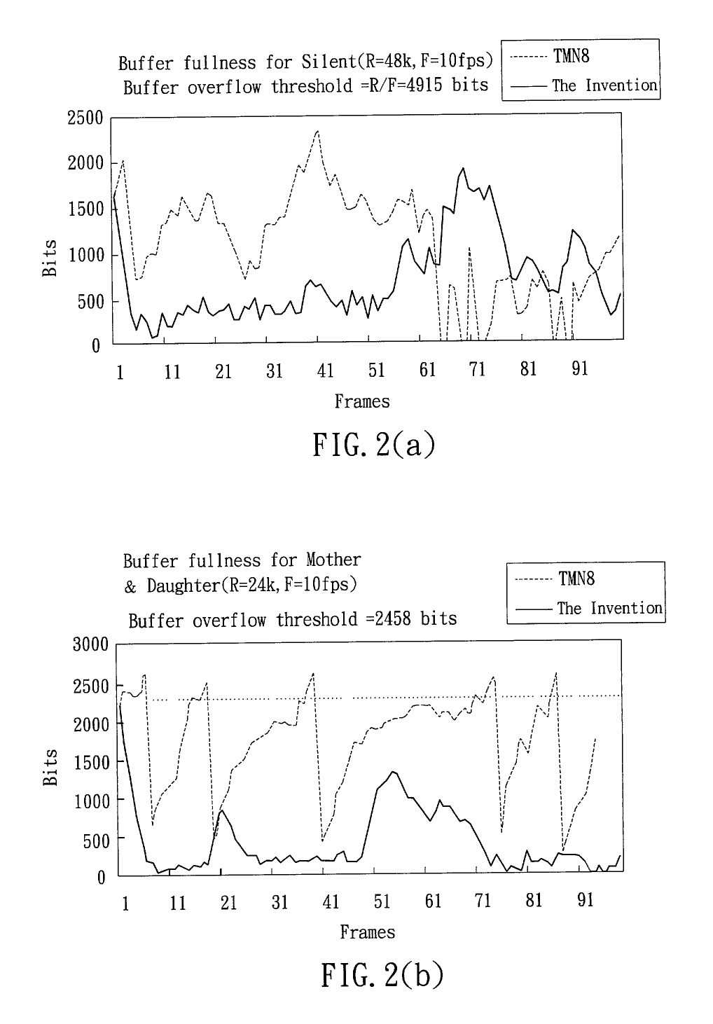

FIGS. 2(a) and 2(b) show the number of bits (i.e. fullness) in the buffer at each frame of different video sequences being encoded respectively by TMN8 and the rate control algorithm of the present invention under different bit rates. In each of the embodiments, the buffer overflow threshold is set to R/F. Therefore, if the buffer fullness is larger than the threshold (called overflow), both rate control schemes skip frames until it is below the threshold. For the video sequence “mother & daughter” at 24 kbps, TMN8 overflows 5 times, which indicates five frames are skipped. However, in the rate control algorithm of the present invention, no overflow occurs for all sequences under various test conditions. Since the number of skipped frames is related to the motion continuity, this implies that the motion continuity of the rate control algorithm of the present invention is superior to that of TMN8. If the curve of the buffer fullness touches the x axis, it yields buffer underflow problem. From FIGS. 2(a) and 2(b), it is apparent that underflow occurs many times in TMN8 for most of sequences; however, only a slight underflow occurs in the rate control algorithm of the present invention. Besides, the rate control algorithm of the present invention achieves lower and steadier buffer fullness.

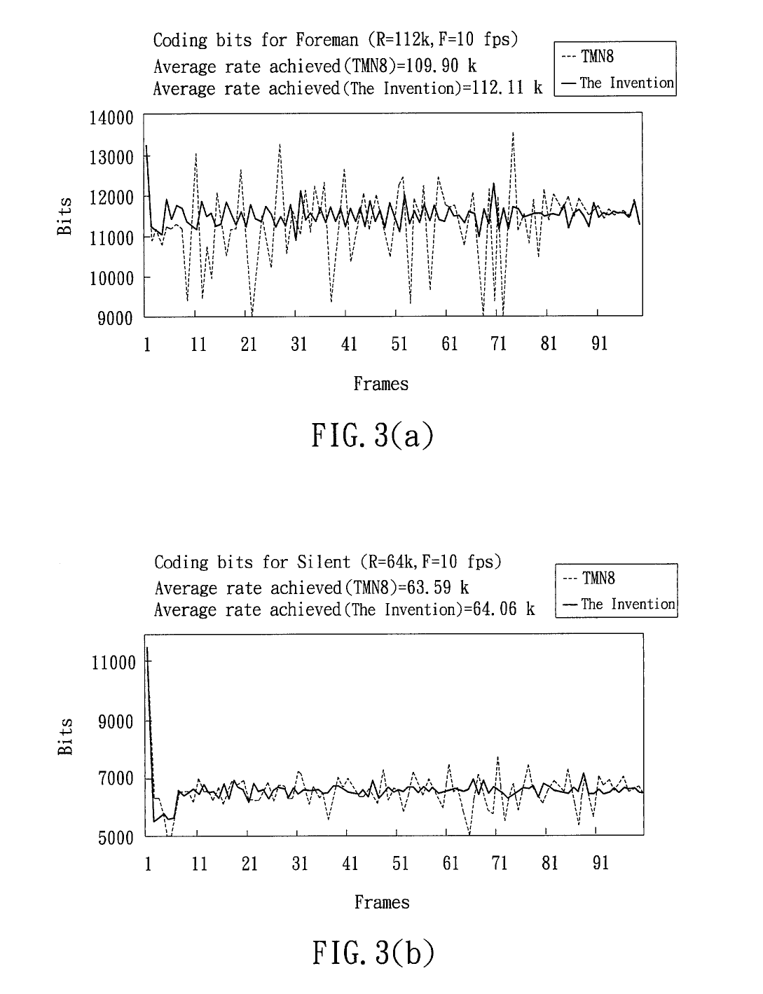

FIGS. 3(a) and 3(b) display the actual coding bit counts at each frame of different video sequences being encoded respectively by TMN8 and the rate control algorithm of the present invention under different bit rates. It apparently indicates that the bit count generated by the rate control algorithm of the present invention for each frame is more uniform and steady than TMN8.

Summing up the above, the dynamic rate table of the present invention will be automatically updated on a MB-by-MB basis by using the actual coding bit counts bₖ′ of the coding MB. Therefore, the rate control algorithm of the present invention can track the variations of video statistics rapidly, control the output bit rate of the video encoder more accurately, and produce better reconstructed picture quality. In addition, the most important advantage is that the present invention only requires fixed-point computation, which not only improves the performance of bit rate control, but also lowers down the cost in hardware implementation significantly.

While the present invention has been described by means of specific embodiments, numerous modifications and variations could be made thereto by those skilled in the art without departing from the scope and spirit of the present invention set forth in the claims.

What is claimed is:

1. A rate control method for real-time video communication by using a dynamic rate table comprising the steps of:
(a) establishing a dynamic rate table under the off-line condition,
(b) estimating the target coding bit count B_{T} of the current frame;
(c) performing initialization to the current frame, of which the initialization including the steps of calculating and recording SAD value and motion vector of every MB, categorizing the MBs into compensable and uncompensable MBs, categorizing the uncompensable MBs into uncompensable inter-coding and intra-coding MBs, calculating the numbers of the uncompensable inter-coding and intra-coding MBs, and recording the numbers into the parameters Nᵢₙₜᵣₐ and Nᵢₙₜₑᵣ respectively;
(d) estimating the number of bits bₖ allocated to the kth uncompensable MB based on SAD_{MB}_{ₖ};
(e) searching the dynamic rate table by using bₖ and SAD_{MB}_{ₖ} of the current MB to obtain an optimal quantization parameter QPₖ, and then adjusting the QPₖ such that the difference value between QPₖ and QPₖ₋₁(the QP of the previous MB) is not greater than 2;
(f) using the resulting QPₖ to quantize and encode the current MB, and then using actual coding bit count to update the dynamic rate table.

2. The method of claim 1, wherein the dynamic rate table is a 2-dimensional matrix b[SAD_{MBk}][QP]; wherein the SAD_{MBk}, denotes the SAD value of the kth MB, and the SAD is an integer in the range of (SADₘᵢₙ, SADₘₐₓ); the QP represents quantization parameter with QP=1,2, . . . ,31; the entry of the matrix represents the estimate of the coding bit counts of a MB (with encoding complexity SAD_{MBk}) that is quantized with a particular QP value.

3. The method of claim 2, wherein the training process of establishing the dynamic rate table comprises the steps of:
(a) feeding training video data into a video encoder on a MB-by-MB basis;
(b) calculating the SAD value of the input MB, and encoding them by using QP values from 1 to 31 respectively;
(c) recording the actual coding bit counts of the input MB after being quantized by each QP value;
(d) repeating the above steps for all MBs, and take the average of the actual coding bit counts for each (SAD, QP) pair, and then store the averages values into the matrix b[SAD_{MBk}][QP] until all entries of the matrix have been finished, the rate table is established.

4. The method of claim 1, wherein the target coding bit counts B_{T} of the current input frame is estimated by using the following equation:
$${B}_{T} = \frac{R}{F} - Δ$$
, wherein Δ is defined below:
$$Δ = \{ \begin{matrix}\frac{2 * W}{F} , & W > Z * M \\ W - Z * M , & otherwise\end{matrix}$$
, wherein W=max(Wₚᵣₑᵥ+D−R/F,0), wherein D is actual number of bits used for encoding the previous frame, Wₚᵣₑᵥ is the previous number of bits in buffer, R is channel rate, and F is frame rate.

5. The method of claim 1, wherein the estimate of bₖ is based on the ratio of the SAD value of the kth MB to the sum of SAD values of all MBs.

6. The method of claim 5, wherein the number of bits bₖ allocated to the kth uncompensable MBs in a frame is calculated by using the following equation:
$${b}_{k} = \frac{{B}_{ava} \times {SAD}_{{MB}_{k}}}{{\sum }_{k = 1}^{N} {SAD}_{{MB}_{k}}}$$
, wherein Bₐᵥₐ is the total number of the bits allocated to the uncompensable MBs; SAD_{MBk} is the SAD value of the kth MB; N is the total number of uncompensable MBs in a frame.

7. The method of claim 6, wherein the number of bits Bₐᵥₐ is estimated by using the following equation:
Bₐᵥₐ=B_{code}−Bₕ₋ᵢₙₜᵣₐ*Nᵢₙₜᵣₐ−Bₕ₋ᵢₙₜₑᵣ*Nᵢₙₜₑᵣ
, wherein Bₕ₋ᵢₙₜᵣₐ is the average header bit counts for intra MBs that have been encoded; Bₕ₋ᵢₙₜₑᵣ is the average header bit counts for inter MBs that have been encoded; Nᵢₙₜᵣₐ is the number of remaining intra MBs; Nᵢₙₜₑᵣ is the number of remaining inter MBs.

8. The method of claim 7, wherein Bₕ₋ᵢₙₜᵣₐ and Bₕ₋ᵢₙₜₑᵣ are calculated in a recursive manner by using the following equations:
$${B}_{h - intra}^{j} = \frac{1}{j} ( {B}_{h - intra}^{i - 1} \times ( j - 1 ) + {b}_{h - intra}^{j} )$$
$${B}_{h - inter}^{j} = \frac{1}{j} ( {B}_{h - inter}^{i - 1} \times ( j - 1 ) + {b}_{h - inter}^{j} )$$
, wherein
$${B}_{h - intra}^{j}$$
is the average header bit counts over j intra MBs (the first MB to the jth MB);
$${b}_{h - int ra}^{j}$$
is the header bit counts for the jth intra MBs;
$${B}_{h - int er}^{J}$$
is the average header bit counts over j inter MBs (the first MB to the jth MB);
$${b}_{h - int er}^{J}$$
is the header bit counts for the jth inter MBs.

9. The method of claim 7, wherein the total number of bits allocated to uncompensable MBs is calculated through the following equation:
B_{code}=B_{T}−B_{uncode}−B_{PH}−B_{GOBH}
, wherein B_{PH} is the bit counts for picture header; B_{GOBH} is the bit counts for GOB headers.

10. The method of claim 7, wherein the partial non-texture information bits for a frame is calculated by using the following equation:
$${B}_{uncode} = {\sum }_{m = 1}^{M} ( {B}_{COD} , {B}_{COD} + {B}_{MCBPC} + {B}_{CBPY} + {B}_{MVD} , {B}_{MVD} , 0 )$$
, wherein M is the total number of MBs in a frame; (X, Y, Z, 0) means to select one from X, Y, Z and 0 depending on the coding modes, where X and Y correspond to the compensable type, Z corresponds to the uncompensable inter-coding, and 0 corresponds to the uncompensable intra-coding; B_{COD} is the number of bits for COD signal; B_{MCBPC} is the number of bits for MCBPC signal; B_{CBPY} is the number of bits for CBPY signal; B_{MVD} is the number of bits for MVD.

11. The method of claim 1, wherein the optimal quantization parameter QPₖ is obtained by minimizing the difference between bₖ and b[SAD_{MBk}][QP].

12. The method of claim 1, wherein the dynamic rate table is automatically updated by using the actual coding bit counts bₖ′ of the current MB on a MB-by-MB basis every time after each macroblock being processed.

13. The method of claim 12, wherein the estimated coding bit counts corresponding to every quantization parameter in the dynamic rate table are updated by using the following equation:
updated coding bit count=b[SAD_{MBk}][QP]+sb[SAD_{MBk}]
, wherein sb[SAD_{MBk}] is a one-dimensional shift array and each SAD value corresponds to an entity of the shift array;
the sb[SAD_{MBk}] is updated by using the following equation:
sb[SAD_{MBk}]=(bₖ′+sb[SAD_{MBk}]−b[SAD_{MBk}][QP])/2

14. The method of claim 1, further comprises the steps of using the QP value to determine PQUANT or GQUANT while the process occurs at the beginning of a GOB;
(a) if no uncompensable MB exists in the GOB, setting GQUANT be any integer in the range of 1 to 31;
(b) if there is only one uncompensable MB in the GOB, setting GQUANT=QP;
(c) if there are at least two uncompensable MBs in the GOB, determining the GQUANT by using the following equation in accordance with the QP values of the first two uncompensable MBs:
$$GQUANT = \{ \begin{matrix}{QP}_{1} + 2 & if {QP}_{2} - {QP}_{1} \geq L , \\ {QP}_{1} & if - L < {QP}_{2} - {QP}_{1} < L \\ {QP}_{1} - 2 & if {QP}_{2} - {QP}_{1} \leq - L\end{matrix}$$
, wherein L is a positive integer.
